(19) United States
(12) Patent Application Publication
(10) Pub. No.: US 2023/0091577 A1
(43) Pub. Date: Mar. 23, 2023

(54) HETEROGENOUS REPLICATION IN A HYBRID CLOUD DATABASE

(71) Applicant: International Business Machines Corporation, Armonk, NY (US)

(72) Inventors: Peng Hui Jiang, Beijing (CN); Hai Dong Xue, Beijing (CN); WEN YI GAO, Beijing (CN); Si Bo Niu, Beijing (CN); Sen Wang, BEIJING (CN); Mei Liu, Beijing (CN)

(21) Appl. No.: 17/479,008

(22) Filed: Sep. 20, 2021

(51) Int. Cl. G06F 16/182; G06F 16/16; G06F 16/14; G06F 21/60; G06F 21/62

(52) U.S. Cl. CPC G06F 16/184; G06F 16/1824; G06F 16/162; G06F 16/148; G06F 21/602; G06F 21/6227

(57) ABSTRACT

Aspects of the invention include splitting a first file retrieved from a first cloud computing environment of a hybrid cloud computing environment into multiple chunks. A respective chunk signature is calculated for each chunk of the multiple chunks, wherein the calculation is based at least in part on static metadata and the dynamic metadata retrieved from the first file. The respective chunk signatures are compared to chunk signatures from a metadata repository to identify a duplicate second file, wherein the first file is a variant of a second file stored in a second cloud computing environment of the hybrid cloud computing environment. Either the first file or the second file is selected as candidate for deletion. The candidate for deletion is deleted.

### BACKGROUND

The present invention generally relates to programmable computing systems, and more specifically, to programmable computing systems configured for heterogenous replication in a hybrid cloud database.

Cloud computing is the on-demand online access to hosted computing resources. A cloud computing environment includes various data centers that host the various computing resources, including applications, servers, networking capabilities. The various data centers share resources to enable the cloud computing environment to process requests and provide services efficiently. Examples of the services enabled through the cloud computing environment include emails, audio, and video streaming, software on demand, and data storage.

A hybrid cloud infrastructure is a composition of two or more clouds (e.g., private, community, and public) that remain unique entities but are bound together by standardized or proprietary technology that enables data and application portability (e.g., cloud bursting for load-balancing between clouds). In the hybrid cloud computing environment, data is stored through various methods by multiple tenants. For example, in a public cloud, the data is generally encrypted with a key (e.g., bring your own key, “BYOK”). Whereas in a private cloud, the data is generally stored using compression and encoding methods. Additionally, in each of the cloud computing environments, data is replicated to generate backup data to provide for fault tolerance (i.e., ability for a system to operate without interruption) in the cloud computing environment. The replication of data introduces data redundancy and consumes memory as multiple copies of the same data are stored in the hybrid cloud computing environment.

### SUMMARY

Embodiments of the present invention are directed to a computer-implemented method for heterogenous replication in a hybrid cloud database. A non-limiting example of the computer-implemented method includes splitting a first file retrieved from a first cloud computing environment of a hybrid cloud computing environment into multiple chunks. A respective chunk signature is calculated for each chunk of the multiple chunks, wherein the calculation is based at least in part on static metadata and the dynamic metadata retrieved from the first file. The respective chunk signatures are compared to chunk signatures from a metadata repository to identify a duplicate second file, wherein the first file is a variant of a second file stored in a second cloud computing environment of the hybrid cloud computing environment. Either the first file or the second file is selected as the candidate for deletion. The selected candidate for deletion is then deleted.

The above described method helps reduce the storage of duplicate data in a hybrid cloud computing environment. Users of respective cloud computing environments that make up the hybrid cloud computing environment store duplicate files in each of their cloud computing environments. These duplicate files contain duplicated content, and can be in different formats due to the requirements of the respective cloud computing environments. Embodiments of the present invention enable the searching for duplicate files across respective cloud computing formats. Once identified, the duplicate portions of the files can be deleted, and a master file can be stored in a central repository that is accessible by each of the cloud computing environments of the hybrid cloud computing environment.

Embodiments of the present invention are also directed to a system for heterogenous replication in a hybrid cloud database. A non-limiting example of the system includes a memory having computer readable instructions; and one or more processors for executing the computer readable instructions, the computer readable instructions controlling the one or more processors to perform operations comprising: splitting a first file retrieved from a first cloud computing environment of a hybrid cloud computing environment into multiple chunks. A respective chunk signature is calculated for each chunk of the multiple chunks, wherein the calculation is based at least in part on static metadata and the dynamic metadata retrieved from the first file. The respective chunk signatures are compared to chunk signatures from a metadata repository to identify a duplicate second file, wherein the first file is a variant of a second file stored in a second cloud computing environment of the hybrid cloud computing environment. Either the first file or the second file is selected as the candidate for deletion. The selected candidate for deletion is then deleted.

Embodiments of the present invention are also directed to a computer program product for heterogenous replication in a hybrid cloud database. A non-limiting example of the computer program product includes a computer readable storage medium having program instructions embodied therewith, the program instructions executable by a processor to cause the processor to perform operations comprising: splitting a first file retrieved from a first cloud computing environment of a hybrid cloud computing environment into multiple chunks. A respective chunk signature is calculated for each chunk of the multiple chunks, wherein the calculation is based at least in part on static metadata and the dynamic metadata retrieved from the first file. The respective chunk signatures are compared to chunk signatures from a metadata repository to identify a duplicate second file, wherein the first file is a variant of a second file stored in a second cloud computing environment of the hybrid cloud computing environment. Either the first file or the second file is selected as the candidate for deletion. The selected candidate for deletion is then deleted.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 illustrates a system for heterogenous replication in a hybrid cloud database according to one or more embodiments of the present invention;

FIG. 2 illustrates a methodology for file splitting according to one or more embodiments of the present invention;

FIG. 3 illustrates a chunk signature table according to one or more embodiments of the present invention;

FIG. 4 illustrates a process for heterogenous replication in a hybrid cloud database according to one or more embodiments of the present invention;

FIG. 5 illustrates a cloud computing environment according to one or more embodiments of the present invention;

FIG. 6 illustrates abstraction model layers according to one or more embodiments of the present invention; and

FIG. 7 illustrates a block diagram of a computer system for use in implementing one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

One or more embodiments of the present invention provide computer-implemented methods, computing systems, and computer program products that identify duplicate data files in a hybrid cloud computing environment and select one more of the duplicated data files for deletion.

One or more embodiments of the present invention address one or more of the above-described shortcomings by providing computer-implemented methods, computing systems, and computer program products that perform the following: splitting a file from a hybrid cloud computing environment into multiple chunks of data. Each chunk is assigned a chunk signature which identifies the content of the chunk and any processing (e.g., encoding, encryption, compress) performed on the chunk. The chunk signatures are compared to chunk signatures stores in a repository to identify duplicate files are stored in the hybrid cloud computing environment. The parameters of each identified duplicate file are compared, and based on the comparison, one or more of the duplicate files are deleted. The remaining files are stored in a universal storage that can be accessed by any cloud computing environment of the hybrid cloud computing environment.

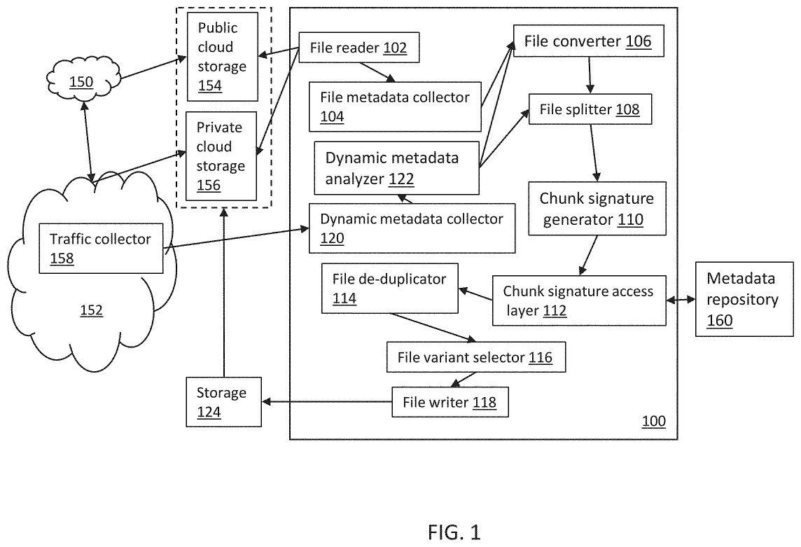

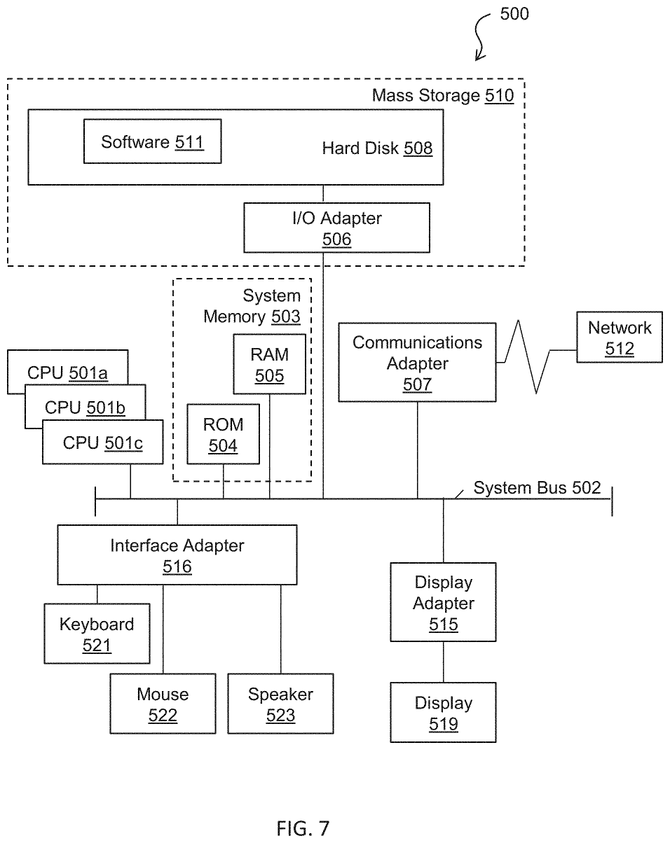

Referring to FIG. 1, a system 100 for file de-duplication is shown in accordance with one or more embodiments of the present invention. The system 100 is in operable communication with a hybrid cloud computing environment, which includes a public cloud 150 and a private cloud 152. The public cloud 150 includes a public cloud storage 154 and the private cloud 152 includes a private cloud storage 156. Each of the public cloud 150 and the private cloud offer services, such as compute services, database services, and storage services. For illustration purposes, the private cloud 152 has been expanded to include a traffic collector 158 in communication with a dynamic metadata collector 120. The public cloud 150 also includes a traffic collector (not shown) in communication with the dynamic metadata collector 120. It should be appreciated that although FIG. 1 only illustrates a public cloud, a private cloud, the system 100 can be in communication with a greater number or type of community cloud computing environments. It should be further appreciated that the functionality of the system 100 as described herein can be effectuated on a computer system, for example, the computer system 700 described in FIG. 7.

The system 100 includes a file reader 102 for receiving files from the public cloud storage 154 and the private cloud storage 156. The files can be readable if in their original format, or the files may have been converted from their original form and unreadable. For example, a file may have been converted to an encrypted format. The file reader 102 employs a file data metadata collector 104, a dynamic metadata collector 120, and a dynamic metadata analyzer 122 to help classify the files.

The file metadata collector 104 collects static metadata from each of the files read by the file reader 102. Static metadata includes information used to determine a variant type of the file (e.g., encryption scheme, encoding scheme, compression scheme, etc.). Two files are variants if the files include duplicate content, but have been processed differently. For example, the file metadata collector 104 reads a file and determines that the file is compressed using a compression1 scheme. The file metadata collector 104 reads another file and determines that this file is compressed using a compression2 scheme. If the two files include the same content, they are variants of each other regardless of the compression scheme. Upon collecting the metadata, the file metadata collector 120 adds a description of the metadata to a file descriptor of the file. The system 100 also includes the dynamic metadata collector 120 for collecting dynamic metadata from the traffic collector 158 of the private cloud 152 and the traffic collector of the public cloud 150. Each traffic collector collects requests data related to operations directed towards the files of the respective public cloud 150 and private cloud 152. The operations include, but are not limited to, the four basic operations create, read, update, and delete (CRUD). The dynamic metadata collector 120 further collects additional information including, but not limited to content type, agent requesting operation, time frame of request, tenant information, and file descriptor.

The dynamic metadata collector 120 transmits collected dynamic metadata and to a dynamic metadata analyzer 122. The dynamic metadata analyzer 122 generates a table associating each file's file descriptor with each of its associated metadata associated For example, if the dynamic metadata collector 120 received a file descriptor and associated operation, then received the same file descriptor with another operation, the dynamic metadata analyzer 122 associates both operations with the same file descriptor.

The system 100 further includes a file converter 106 for receiving static metadata and using that metadata to convert a file back to its original readable format. The file converter 106 includes decryption, an engine, a decompression engine, and a decode engine for assisting with the conversion. The file converter 106 receives static metadata from the file metadata collector 104 and dynamic metadata from dynamic metadata analyzer 122. Based on the received metadata, the file converter 106 determines any conversion scheme used to process the file. The file converter 106 accesses the appropriate engine and converts a file back to its original readable format. For example, the file converter 106 receives an identity of an encryption scheme for an encrypted file from the file metadata collector 104. The file converter 106 then retrieves an applicable decryption scheme from the encryption engine and unencrypts the file.

The system 100 includes a file splitter 108 for receiving a file from the file converter 106 and splitting the file into chunks of data, where each chunk is a fragment of the file. The file splitter 108 is provided a default value for a size and region of each chunk (e.g., 255 kilobytes). If the dynamic metadata analyzer indicates that the file was not modified, the file splitter 108 divides each file by the predetermined size and region until the variant files are divided into an equal number of chunks. The last chunk only holds as much data as remains in the file. Each chunk is stored as a document, where the documents can be an image file, text file, audio file, video file, or other data file. If the dynamic metadata analyzer 122 indicates that the file was modified, the size of the chunks is calculated to include modified portions of the file in single chunks.

Each chunk is given a signature in the form of a header by the chunk signature generator 110. A chunk signature describes a positioning of a chunk in relation to a file. By reading the chunk signature, the chunks can be reassembled in the correct order to reach the original file. For example, the chunk signature generator 110 can generate chained chunk signatures. The chunk signature generator 110 can generate a seed signature for the first chunk. Moving forward, the chunk signature generator 110 includes the previous chunk signature in a subsequent chunk signature for a subsequent chunk.

In addition to ordering the chunks, the signature includes a description of each variant characteristic of a chunk, including a description of the content of the data included in the chunk. The various characteristics were previously identified by the file metadata collector 104 and the dynamic data analyzer 122. For example, the chunk signature identities a compression algorithm that was used to compress the data forming the chunk. Once the chunk signature generator 110 has generated a signature for each chunk, the signatures are stored in a metadata repository 160.

A chunk signature access layer 112 compares the content descriptions included in the chunk signatures stored in the metadata repository 160. Based on the comparisons, the chunk signature access layer 112 determines if any duplicate files are found in the public cloud storage 154 and private cloud storage 156 of the hybrid cloud computing environment. The chunk signature access layer 112 can compare the chunk signatures and determine whether a threshold number of chunks of two or more files are duplicates. The threshold can be based on a number of chunks or a percentage of total data. If the threshold number of chunks are duplicate chunks, the chunk signature access layer 112 deems the files as duplicates. If the threshold number of chunks are not duplicate chunks, the chunk signature access layer 112 does not deem the files as duplicates.

The file de-duplicator 114 receives the identifies of the files deemed duplicates identifies each file that is a candidate for de-duplication. The file de-duplicator 114 reads the chunk signatures and further determines whether any of the duplicate files are variants of each other.

The file variant selector 116 receives information on the files tagged for de-duplication and determines which of the one or more duplicate files to erase. The duplicate files to be erased can either be identical or variants of each other. In the instance that more than one file is a duplicate of another file without any variation, the file variant selector selects the duplicate file that is accessed the highest number of times over a given period of time and deletes the other duplicate files. If the duplicate files are variants of each other, the file variant selector considers various parameters to make a determination, including the frequency of accessed variant files, the number of variant files in a current format, conversion cost from one variant format to another format, and distribution of variant files of different cloud storages.

The file variant selector's decision is transmitted to a file writer 118. The file writer 118 rewrites the file to incorporate each of the variant characteristics to place the file in the format that it was stored in either the public cloud storage 154 or private cloud storage 156. The file writer 118 then stores the rewritten file in storage 124, which is accessible to both the public cloud storage 154 and the private cloud storage 156.

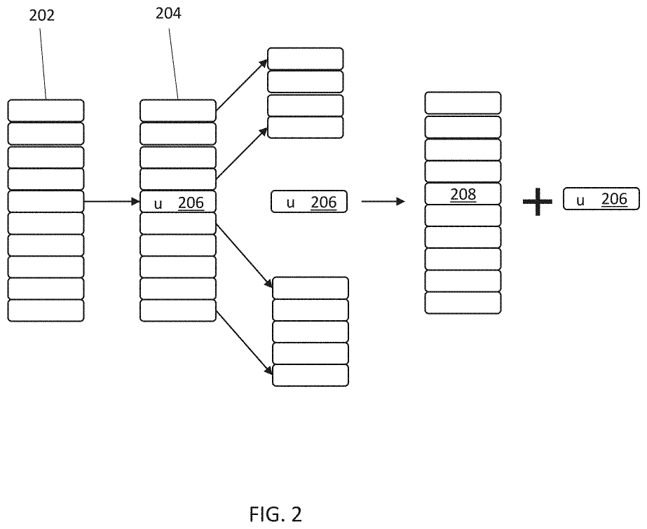

Referring to FIG. 2, an illustration of file splitting is shown in accordance with one or more embodiments of the present invention. The file splitter 108 subdivides a first file 202 into ten chunks, and a second file 204 is subdivided into ten chunks. The first file 202 was stored in the public cloud storage 154, and the second file 204 was stored in the private cloud storage 156. The dynamic metadata collector 120 has received traffic indicating that a consumer of the private cloud 152 initiated an update operation on a chunk of the second file. Therefore, nine chunks of the second file 204 are duplicates of nine chunks of the first file 202. The updated chunk of the second file 204 is different than the remaining chunk of the first file 202.

Downstream in the process, the file variant selector 116 determines that the first file 202 should remain and the second file 204 should be erased. In order to preserve the information of the updated chunk 206, the nine duplicate chunks of the second file are deleted, and the updated chunk 206 is preserved. The file writer 118 writes both the first file 202 and the updated chunk 206 to storage 124. The file writer 118 further updates the chunk signature of both the updated chunk 206 and the corresponding chunk 208 to indicate that, if a consumer of the private cloud 152 requests the file, the corresponding chunk 208 can be replaced by the updated chunk 206. Additionally, if a consumer of the public cloud 150 requests the file, the corresponding chunk 208 can remain.

As an example, suppose the first file 202 is stored in the public cloud storage 154, and the second file 204 is stored in the private cloud storage 156. A consumer of the private cloud 152 requests an update of a chunk of the second file 204, and the request is processed. Afterward, the first file 202 and the second file 204 are selected as de-duplication candidates, and ultimately the second file 204 is selected to be erased. The file writer 118 writes both the first file 202 and the updated chunk 206 to storage 124. If a consumer of the public cloud 150 requests the first file 202, the public cloud storage 154 reads the chunk signatures and determines that the first file 202 should be retrieved as is. If, however, a consumer of the private cloud 152 requests the first file 202, the private cloud storage 156 reads the chunk signatures and determines that the corresponding chunk 208 should be replaced by the updated chunk 206.

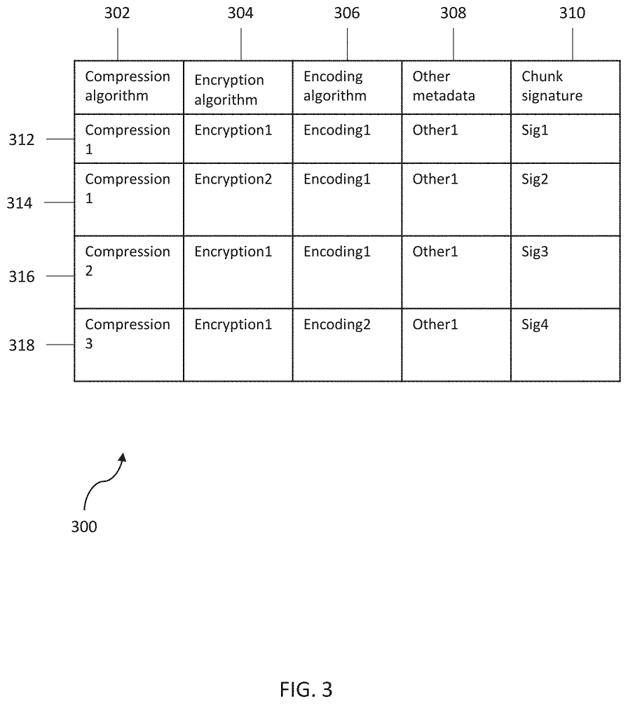

Referring to FIG. 3, a chunk signature table 300 for a file divided into four chunks is shown in accordance with one or more embodiments of the present invention. The table 300 includes a compression algorithm column 302, an encryption algorithm column 304, and encoding algorithm column 306, an other metadata column 308, and a chunk signature column 310. The table 300 further includes a first row 312 for a first chunk, a second row 314 for a second chunk, a third row 316 for a third chunk, and a fourth row 318 for a fourth chunk. As illustrated by the first row 312, the data of the first chunk was compressed using a compression1 algorithm, encrypted using an encryption1 algorithm, encoded using an encoding1 algorithm, and further includes other1 metadata. The chunk signature generator 110 has further generated Sig1 as a signature of the chunk. Sig1 includes information that this chunk is the sequentially first chunk of the file. The content of the first chunk is included in the other metadata column 308

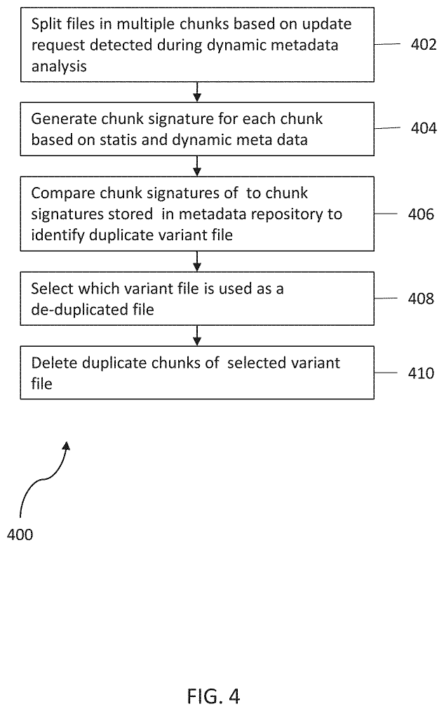

Referring to FIG. 4, a process flow 400 for heterogenous replication in a hybrid cloud database is shown in accordance with one or more embodiments of the present invention. At block 402, a file splitter 108 receives a first file from a cloud computing environment of a hybrid cloud computing environment. The file splitter splits the first file into multiple chunks of data. As a default, the file splitter 108 splits the first file into predetermined data sizes. If, however, the file splitter 108 has received dynamic metadata indicating that a consumer of the cloud computing environment has requested to create, read, update, or delete a portion of the first file, the file splitter 108 splits the first file such that the created, read, or updated portion is a single chunk, and; if deleted, a placeholder chunk is created to replace the deleted portion.

At block 404, a chunk signature generator 110 calculates a respective chunk signature for each chunk of the first file. Each chunk signature identifies a position of the chunk in relation to the first file. The chunk signature also identifies any encoding scheme, compression scheme, encryption scheme, and other conversion scheme used to convert the file stored in a cloud computing environment. In addition, the chunk signature identifies a format of the chunk, for example, image file, text file, audio file etc. The chunk signature further identifies the content of the data in the respective chunk.

At block 406, a chunk signature access layer 112 can compare the chunk signatures of the first file to chunk signatures for files stored in a metadata repository 160 to identify a duplicate second file. The duplicate second file can include a variant of the first file. However, as long as the content of the first file is a duplicate of the content of the second file, the files are duplicate variants of each other. Furthermore, the chunks of the first file and the second file do not have to have all duplicate chunks. The chunk signature access layer 112 can compare the chunk signatures and determine whether a threshold number of chunks are duplicates. The threshold can be based on a number of chunks or a percentage of total data. For example, a first file has fifteen chunks, and a second file had fifteen chunks. Twelve chunks of the first file are duplicates of twelve chunks of the second file, and three files of the second file are updated versions of three chunks of the first file. If twelve chunks are greater than the threshold number of chunks, the first file is a duplicate of the second file. If twelve chunks are not greater than the threshold number of chunks, the first file is not a duplicate of the second file.

At block 408, a file variant selector 116, compares parameters of the first file and the second file to determine which variant file to delete. The parameters include, but are not limited to, the frequency of accessed variant files, the number of variant files in a current format, conversion cost from one variant format to another format, and distribution of variant files of different cloud storages. Revisiting the example from above, regardless of which of the second file or the first file that the file variant selector 116 chooses to delete, the three non-duplicate chunks of the file selected for deletion are retained.

At block 410, a file writer 118 deletes the file selected for deletion and rewrites the file to reintroduce any conversion, such the retained file is in the same format as when stored in either the public cloud storage 154 or private cloud storage 156. For example, if the file writer 118 can read the static metadata and determine that the file was in a compressed format. The file writer 118 can access the compression scheme and rewrite the file back to the compressed format. The file writer 118 further anchors the rewritten file to any retained chunks from the deleted file. Again, revisiting the example from above, if whichever of the first file or second file that the file variant selector 116 chooses to delete, the file writer 118 rewrites the three non-duplicate chunks in their converted format. The file writer 118 further adds an anchor (e.g., a pointer) to the file that the file variant selector 116 chose to retain. The anchor links the rewritten first file to the three non-duplicate chunks of the deleted file. The file writer 118 further stores the rewritten file into storage 124. The storage 124 is accessible to both the public cloud storage 154 and private cloud storage 156.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

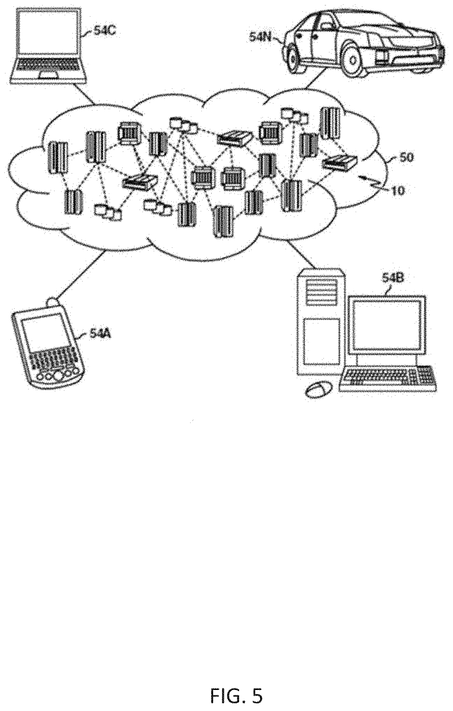

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

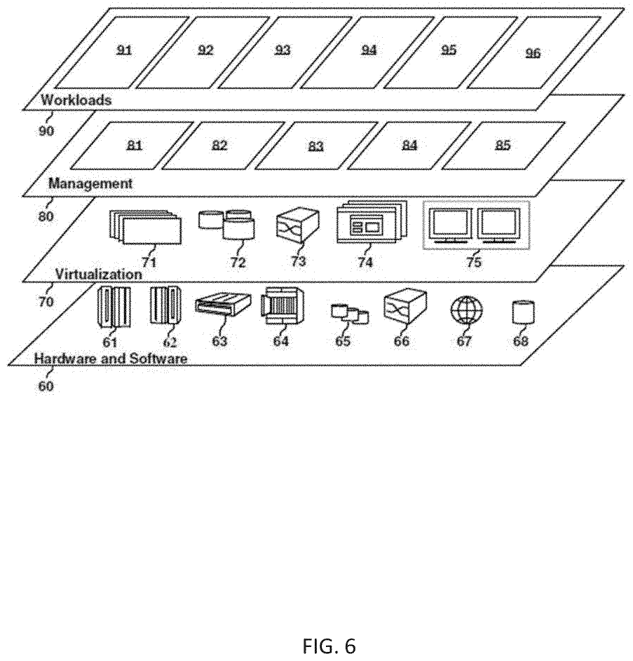

Referring now to FIG. 6, a set of functional abstraction layers provided by cloud computing environment 50 (FIG. 6) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtualization 93; data analytics processing 94; transaction processing 95; and heterogenous replication in hybrid-cloud database 96.

In one or more embodiments of the present invention, the hardware/software modules in the system 100 from FIG. 1 can be implemented on the computer system 700 found in FIG. 7. Turning now to FIG. 7, a computer system 700 is generally shown in accordance with an embodiment. The computer system 700 can be an electronic, computer framework comprising and/or employing any number and combination of computing devices and networks utilizing various communication technologies, as described herein. The computer system 700 can be easily scalable, extensible, and modular, with the ability to change to different services or reconfigure some features independently of others. The computer system 700 may be, for example, a server, desktop computer, laptop computer, tablet computer, or smartphone. In some examples, computer system 700 may be a cloud computing node, such as a node 10 of FIG. 5. Computer system 500 may be described in the general context of computer system executable instructions, such as program modules, being executed by a computer system. Generally, program modules may include routines, programs, objects, components, logic, data structures, and so on that perform particular tasks or implement particular abstract data types. Computer system 700 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, the computer system 700 has one or more central processing units (CPU(s)) 701a, 701b, 701c, etc. (collectively or generically referred to as processor(s) 701). The processors 701 can be a single-core processor, multi-core processor, computing cluster, or any number of other configurations. The processors 701, also referred to as processing circuits, are coupled via a system bus 702 to a system memory 703 and various other components. The system memory 703 can include a read only memory (ROM) 704 and a random access memory (RAM) 705. The ROM 704 is coupled to the system bus 702 and may include a basic input/output system (BIOS), which controls certain basic functions of the computer system 700. The RAM is read-write memory coupled to the system bus 702 for use by the processors 701. The system memory 703 provides temporary memory space for operations of said instructions during operation. The system memory 703 can include random access memory (RAM), read only memory, flash memory, or any other suitable memory systems.

The computer system 700 comprises an input/output (I/O) adapter 706 and a communications adapter 707 coupled to the system bus 702. The I/O adapter 706 may be a small computer system interface (SCSI) adapter that communicates with a hard disk 708 and/or any other similar component. The I/O adapter 706 and the hard disk 708 are collectively referred to herein as a mass storage 710.

Software 711 for execution on the computer system 700 may be stored in the mass storage 710. The mass storage 710 is an example of a tangible storage medium readable by the processors 701, where the software 711 is stored as instructions for execution by the processors 701 to cause the computer system 700 to operate, such as is described herein below with respect to the various Figures. Examples of computer program product and the execution of such instruction is discussed herein in more detail. The communications adapter 707 interconnects the system bus 702 with a network 712, which may be an outside network, enabling the computer system 700 to communicate with other such systems. In one embodiment, a portion of the system memory 703 and the mass storage 710 collectively store an operating system, which may be any appropriate operating system, such as the z/OS or AIX operating system from IBM Corporation, to coordinate the functions of the various components shown in FIG. 7.

Additional input/output devices are shown as connected to the system bus 702 via a display adapter 715 and an interface adapter 516 and. In one embodiment, the adapters 706, 707, 715, and 716 may be connected to one or more I/O buses that are connected to the system bus 702 via an intermediate bus bridge (not shown). A display 719 (e.g., a screen or a display monitor) is connected to the system bus 702 by a display adapter 715, which may include a graphics controller to improve the performance of graphics intensive applications and a video controller. A keyboard 721, a mouse 722, a speaker 723, etc. can be interconnected to the system bus 702 via the interface adapter 716, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 7, the computer system 700 includes processing capability in the form of the processors 701, and, storage capability including the system memory 703 and the mass storage 710, input means such as the keyboard 721 and the mouse 722, and output capability including the speaker 723 and the display 719.

In some embodiments, the communications adapter 707 can transmit data using any suitable interface or protocol, such as the internet small computer system interface, among others. The network 712 may be a cellular network, a radio network, a wide area network (WAN), a local area network (LAN), or the Internet, among others. An external computing device may connect to the computer system 700 through the network 712. In some examples, an external computing device may be an external webserver or a cloud computing node.

It is to be understood that the block diagram of FIG. 7 is not intended to indicate that the computer system 700 is to include all of the components shown in FIG. 7. Rather, the computer system 700 can include any appropriate fewer or additional components not illustrated in FIG. 7 (e.g., additional memory components, embedded controllers, modules, additional network interfaces, etc.). Further, the embodiments described herein with respect to computer system 700 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
splitting, by a processor, a first file retrieved from a first cloud computing environment of a hybrid cloud computing environment into multiple chunks;
calculating, by the processor, a respective chunk signature for each chunk of the multiple chunks, wherein the calculation is based at least in part on static metadata and the dynamic metadata retrieved from the first file;
comparing, by the processor, the respective chunk signatures to chunk signatures from a metadata repository to identify a duplicate second file, wherein the first file is a variant of a second file stored in a second cloud computing environment of the hybrid cloud computing environment;
determining, by the processor, which of the first file or second file is a candidate for deletion; and
deleting, by the processor, the candidate for deletion.

2. The computer-implemented method claim 1, wherein the method further comprises:
analyzing the first file to detect static metadata comprising at least one of an encryption scheme used to encrypt the first file, a compression scheme used to compress the first file, and an encoding scheme used to encode the first file, and
performing at least one of the following:
unencrypting the first file based on the encryption scheme,
uncompressing the first file based on the compression scheme, and
decoding the first file based on the encoding scheme.

3. The computer-implemented method claim 1, wherein the method further comprises:
analyzing the first file to detect dynamic metadata comprising at least one of the following: creating data for the first file, updating data for the first file, reading data of the first file, and deleting data of the first file; and
calculating the chunk size based at least in part on the data size.

4. The computer-implemented method of claim 1, wherein the method further comprises:
determining that a first chunk of the second file is an updated version of a first chunk of the first file;
deleting the second file, wherein deleting the second file comprises retaining the first chunk of the second file and deleting a balance of the chunks of the second file; and
retaining the first file.

5. The computer-implemented method of claim 1, wherein determining which of the first file or second file is a candidate for deletion comprises:
comparing the first file and the second file based on the frequency of access of the first file and the second file; and
selecting whichever of the first file and the second file is accessed the least frequently.

6. The computer-implemented method of claim 1, wherein the method further comprises storing whichever of the first file or the second file is retained in a storage accessible by the first cloud computing environment and the second cloud computing environment.

7. The computer-implemented method of claim 1, wherein the first cloud computing environment is a private cloud, and the second cloud computing environment is a public cloud.

8. A system comprising:
a memory having computer readable instructions; and
one or more processors for executing the computer readable instructions, the computer readable instructions controlling the one or more processors to perform operations comprising:
splitting a first file retrieved from a first cloud computing environment of a hybrid cloud computing environment into multiple chunks;
calculating a respective chunk signature for each chunk of the multiple chunks, wherein the calculation is based at least in part on static metadata and the dynamic metadata retrieved from the first file;
comparing the respective chunk signatures to chunk signatures from a metadata repository to identify a duplicate second file, wherein the first file is a variant of a second file stored in a second cloud computing environment of the hybrid cloud computing environment;
determining which of the first file or second file is a candidate for deletion; and
deleting the candidate for deletion.

9. The system of claim 8, wherein the operations further comprise:
analyzing the first file to detect static metadata comprising at least one of an encryption scheme used to encrypt the first file, a compression scheme used to compress the first file, and an encoding scheme used to encode the first file, and
performing at least one of the following:
unencrypting the first file based on the encryption scheme,
uncompressing the first file based on the compression scheme, and
decoding the first file based on the encoding scheme.

10. The system of claim 8, wherein the operations further comprise:
analyzing the first file to detect dynamic metadata comprising at least one of the following: creating data for the first file, updating data for the first file, reading data of the first file, and deleting data of the first file; and
calculating the chunk size based at least in part on the data size.

11. The system of claim 8, wherein the operations further comprise:
determining that a first chunk of the second file is an updated version of a first chunk of the first file;
deleting the second file, wherein deleting the second file comprises retaining the first chunk of the second file and deleting a balance of the chunks of the second file; and
retaining the first file.

12. The system of claim 8, wherein determining which of the first file or second file is a candidate for deletion comprises:
comparing the first file and the second file based on the frequency of access of the first file and the second file; and
selecting whichever of the first file and the second file is accessed the least frequently.

13. The system of claim 8, wherein the operations further comprise storing whichever of the first file or the second file is retained in a storage accessible by the first cloud computing environment and the second cloud computing environment.

14. The system of claim 8, wherein the first cloud computing environment is a private cloud, and the second cloud computing environment is a public cloud.

15. A computer program product comprising a computer readable storage medium having program instructions embodied therewith, the program instructions executable by a processor to cause the processor to perform operations comprising:
splitting a first file retrieved from a first cloud computing environment of a hybrid cloud computing environment into multiple chunks;
calculating a respective chunk signature for each chunk of the multiple chunks, wherein the calculation is based at least in part on static metadata and the dynamic metadata retrieved from the first file;
comparing the respective chunk signatures to chunk signatures from a metadata repository to identify a duplicate second file, wherein the first file is a variant of a second file stored in a second cloud computing environment of the hybrid cloud computing environment;
determining which of the first file or second file is a candidate for deletion; and
deleting the candidate for deletion.

16. The computer program product of claim 15, wherein the operations further comprise:
analyzing the first file to detect static metadata comprising at least one of an encryption scheme used to encrypt the first file, a compression scheme used to compress the first file, and an encoding scheme used to encode the first file, and
performing at least one of the following:
unencrypting the first file based on the encryption scheme,
uncompressing the first file based on the compression scheme, and
decoding the first file based on the encoding scheme.

17. The computer program product of claim 15, wherein the operations further comprise:
analyzing the first file to detect dynamic metadata comprising at least one of the following: creating data for the first file, updating data for the first file, reading data of the first file, and deleting data of the first file; and
calculating the chunk size based at least in part on the data size.

18. The computer program product of claim 15, wherein the operations further comprise:
determining that a first chunk of the second file is an updated version of a first chunk of the first file;
deleting the second file, wherein deleting the second file comprises retaining the first chunk of the second file and deleting a balance of the chunks of the second file; and
retaining the first file.

19. The computer program product of claim 15, wherein determining which of the first file or second file is a candidate for deletion comprises:
comparing the first file and the second file based on the frequency of access of the first file and the second file; and
selecting whichever of the first file and the second file is accessed the least frequently.

20. The computer program product of claim 15, wherein the operations further comprise storing whichever of the first file or the second file is retained in a storage accessible by the first cloud computing environment and the second cloud computing environment.
